(19) United States
(12) Patent Application Publication
(10) Pub. No.: US 2024/0392418 A1
(43) Pub. Date: Nov. 28, 2024

(54) COMPOSITE WEAR COMPONENT

(71) Applicant: Magotteaux International S.A., Vaux-sous-Chevremont (BE)

(72) Inventor: Stéphane DESILES, Aywaille (BE)

(21) Appl. No.: 18/690,951

(22) PCT Filed: Sep. 1, 2022
(86) PCT No.: PCT/EP2022/074347

§ 371 Date: Mar. 11, 2024

(30) Foreign Application Priority Data
Sep. 23, 2021 (EP) 21198590.8

(51) Int. Cl. C22C 29/10; B22F 1/148; B22F 3/12; B22F 3/26; B22F 9/04; C22C 1/051; C22C 29/06; C22C 37/06; C22C 38/02; C22C 38/04; C22C 38/42; C22C 38/44

(52) U.S. Cl. CPC C22C 29/10; B22F 1/148; B22F 3/12; B22F 3/26; B22F 9/04; C22C 1/051; C22C 29/067; C22C 37/06; C22C 38/02; C22C 38/04; C22C 38/42; C22C 38/44; B22F 2009/043; B22F 2302/10; B22F 2302/15; B22F 2302/20; B22F 2998/10; B22F 2999/00

(57) ABSTRACT

A hierarchical composite wear component includes a reinforced part and a non-reinforced part, the reinforced part including a three-dimensionally interconnected network of periodically alternating millimetric ceramic-metal composite granules with millimetric interstices. The ceramic-metal composite granules have at least 52 vol % micrometric particles of titanium carbide embedded in a first metal matrix, the porosity of the ceramic-metal composite granules being lower than 5 vol %. The three-dimensionally interconnected network of ceramic-metal composite granules is embedded in a second metal matrix. The volume content of ceramic-metal composite granules in the reinforced part is 45 to 65 vol %. The composition of the first metal matrix is substantially different from the second metal matrix. The second metal matrix has the ferrous cast alloy present in the millimetric interstices of the reinforced part. The millimetric interstices additionally include at least 1 vol % of micrometric carbide particles.

### FIELD

The present disclosure relates to a hierarchical composite wear component having an improved resistance to the combined wear/impact stresses and obtained by cast technology. present disclosure

### BACKGROUND

The present disclosure relates to wear components employed in the grinding and crushing industry such as cement factories, quarries and mines. These components are often subjected to high mechanical stresses in the bulk and to high wear by abrasion at the working faces. It is therefore desirable that these components should exhibit a high abrasion resistance and some ductility to be able to withstand mechanical stresses such as impacts.

Given that these two properties are difficult to match with the same material composition, composite components having a core made of relatively ductile alloy in which ceramic inserts of good wear resistance are embedded have been proposed in the past.

Document U.S. Pat. No. 4,119,459 (Sandvik, 1977) discloses a composite wear body composed of cast iron and sintered cemented carbide crushed granules. The cemented carbide, in a binder metal, is of WC-Co-type with possible additions of carbides of Ti, Ta, Nb or other metals. No indication is given about the volume percentage of possible TiC in the granules or in the reinforced part of the body.

Document U.S. Pat. No. 4,626,464 (Krupp, 1984) discloses a beater which is to be installed in a hammer comprising a metal alloy basic material and a wear resistant zone containing hard metal particles in addition to a ferroalloy, the hard metal particles have a diameter of from 0.1 to 20 mm and the percentage of the hard metal particles in the wear resistant zone lies between 25 and 95 volume percent; and wherein said hard particles are firmly embedded within said metal alloy basic material. The average volume concentration of possible TiC in the reinforced part is not disclosed in this document.

U.S. Pat. No. 5,066,546 (Kennametal, 1989) discloses a hierarchical wear resistant body comprising at least one layer of a series of carbide material, among which titanium carbide embedded in a casted steel matrix. The carbide material has a particle size between 4.7 and 9.5 mm wherein said carbide material is in the form of crushed parts, powder or pressed bodies having an irregular shape. This document neither discloses the average concentration of TiC in the reinforced part of the wear body nor the constitution of the reinforcing structure.

Document U.S. Pat. No. 8,999,518 B2 (Magotteaux) discloses a hierarchical composite material comprising a ferrous alloy reinforced with titanium carbide according to a defined geometry, in which said reinforced portion comprises an alternating macro-microstructure of millimetric areas that are concentrated with micrometric globular particles of titanium carbide separated by millimetric areas that are essentially free of micrometric globular particles of titanium carbide, said areas being filled by a ferrous alloy. In this patent, the maximum TiC concentration is 72.2 vol % when a powder blend of Ti and C is compacted at a maximum relative density of 95%. The porosity of the granules is higher than 5 vol % and, in absence of a possible reaction moderator, only one metal matrix, the cast metal, is present. The hierarchical composite material is obtained by self-propagating high temperature synthesis (SHS), where reaction temperatures generally above 1,500° C., or even 2,000° C., are reached. Only little energy is needed for locally initiating the reaction. Then, the reaction will spontaneously propagate to the totality of the mixture of the reagents. Example 4 of this document will be used herein as a comparative example of the present disclosure.

The hierarchical composite of this document is obtained by the reaction in a mold of granules comprising a mixture of carbon and titanium powders. After initiation of the reaction, a reaction front develops, which thus propagates spontaneously (self-propagating) and which allows titanium carbide to be obtained from titanium and carbon. The thereby obtained titanium carbide is said to be “obtained in situ” because it is not provided from the cast ferrous alloy (Ti+C→TIC SHS reaction is very exothermic with a theoretical adiabatic temperature of 3290K). This reaction is initiated by the casting heat of the cast iron or the steel used for casting the whole part.

Unfortunately, the rise in temperature of major amounts of carbon and titane causes degassing of the reactants i.e. the volatiles contained therein (H₂O in carbon, H₂, N₂ in titanium). All impurities contained in the reactant powders, organic or inorganic components around or inside the powder/compacted grains, are volatilized. To attenuate the intensity of the reaction between the carbon and the titanium, powder of a ferrous alloy is added therein as moderator to absorb the heat and decrease the temperature. Nevertheless, this also decreases the maximum obtainable TiC concentration in the final wear part and the above-mentioned theoretical concentration of 72.2% is not attainable in practice on the production scale.

Document WO 2010/031663A1 relates to a composite impactor for percussion crushers, said impactor comprising a ferroalloy which is at least partially reinforced with titanium carbide in a defined shape according to the same method than the document U.S. Pat. No. 8,999,518 B2 previously described. To attenuate the intensity of the reaction between the carbon and titanium, ferrous alloy powder is added. In an example of this document, the reinforced areas comprise a global volume percentage of about 30% of TiC. To this end, a strip of 85% relative density is obtained by compaction. After crushing the strip, the obtained granules are sieved so as to reach a dimension between 1 and 5 mm, preferably 1.5 and 4 mm. A bulk density in the range of 2 g/cm³ is obtained (45% space between the granules+15% porosity in the granules). The granules in the wear part to be reinforced thus comprise 55 vol % of porous granules. In such case, the concentration of TiC in the reinforced area is only 30% which is not always sufficient and likely to have a negative impact on the wear performance of the casting, in particular with grains of high porosity before the SHS reaction.

Document US 2018/0369905A1 discloses a method providing a more precise control of the SHS process during casting by using a moderator. The casting inserts are made from a powder mixture comprising the reactants of TiC formation and a moderator having the composition of cast high-manganese steel containing 21% Mn.

### SUMMARY

The present disclosure aims to provide a hierarchical composite wear component produced by conventional casting comprising a metal matrix in cast iron or steel, integrating a reinforced structure with a high concentration of micrometric titanium carbide particles embedded in a metallic binder, called herein the first metal matrix, forming low porosity ceramic-metal composite granules. The first metallic matrix including the micrometric titanium carbide particles of the reinforced part is different from the metal matrix present in the rest of the composite wear component. The reinforced structure also comprises millimetric interstices, periodically alternating with the ceramic-metal composite granules, the millimetric interstices comprising micrometric carbide particles formed in situ during the casting operation and embedded in the second metal matrix. The wear component comprises a three dimensional network of aggregated millimetric ceramic-metal composite granules with millimetric interstices wherein TiC based micrometric particles are embedded in a binder, called “the first metal matrix”, the millimetric interstices being filled during the casting of the wear component by the cast metal, called “the second metal matrix” in the present disclosure, the filled interstices additionally comprising micrometric carbide particles formed in situ trough carbide forming metal powders combined to a carbon source, either coming from an organic glue or from the cast metal itself.

An aim of the present disclosure is to increase the carbide concentration, even within the interstices filled by the second metal matrix (the cast metal).

Another aim of the present disclosure is to provide a safe manufacturing process of reinforced composite wear parts, avoiding the release of gases, providing an improved composite wear component, with a good resistance to impacts and corrosion.

In the present disclosure, the expression “interstice” should be understood as a space separating at least two aggregated millimetric ceramic-metal composite granules. During the casting, said interstices are filled with the cast metal, which is substantially free of ceramic-metal composite particles, but which contains at least 3% of dispersed carbide particles formed in situ via the presence of carbide forming metals present around the millimetric ceramic-metal composite granules. The aggregated millimetric ceramic-metal composite granules forming a three dimensional interconnected network are covered or coated by a powder of carbide forming metals which simply sticks to the organic glue used to agglomerate said granules. In an alternative process, the agglomerate of millimetric ceramic-metal composite granules is immerged in a liquid solution or dispersion of metal particles or salts to obtain an infiltration of said carbide forming metals in the interstices of the millimetric granules and dried afterwards.

In the present disclosure, the expression “ceramic-metal composite granules” should be understood as granular particles of a few millimetres mainly comprising ceramic-metal composite particles, i.e. ceramic particles embedded in a first metal matrix, said particles being later embedded in the second metal matrix, the cast metal matrix during the cast operation.

A heterogeneous space made up of particles of different sizes and natures cannot be described otherwise than by definitions of spaces filled or not with the particles in question. As shown in FIGS. 5 and 6, grains are adhesively bound in a three dimensional ceramic composite network, preferably by an organic adhesive, creating a reinforced wear part with a three dimensional structure with interstices to be filled during the casting.

A first aspect of the present disclosure relates to a hierarchical composite wear component comprising a reinforced part and a non-reinforced part, the reinforced part comprising a three-dimensionally interconnected network of periodically alternating millimetric ceramic-metal composite granules with millimetric interstices, said ceramic-metal composite granules comprising at least 52 vol %, preferably at least 61 vol %, more preferably at least 70 vol % of micrometric particles of titanium carbide embedded in a first metal matrix, the three-dimensionally interconnected network of ceramic-metal composite granules with its millimetric interstices being embedded in a second metal matrix, said reinforced part comprising in average at least 23 vol %, more preferably at least 28 vol %, most preferably at least 30 vol % of titanium carbide, the composition of the first metal matrix being substantially different from the composition of the second metal matrix, the second metal matrix comprising the ferrous cast alloy present in the millimetric interstices of the reinforced part, said millimetric interstices additionally comprise at least 1 vol %, preferably 3 vol % of micrometric carbide particles selected from the group consisting of tungsten carbide, vanadium carbide, molybdenum carbide, titanium carbide, niobium carbide, hafnium carbide and zirconium carbide or mixtures thereof, the volume percentage being determined according to ISO 13383-2:2012.

According to preferred embodiments of the present disclosure, the composite wear component is further characterized by one of the following features or by a suitable combination thereof:
the ceramic-metal composite granules have a density comprised between 4.8 g/cm³ and 6 g/cm², preferably between 5 g/cm³ and 5.6 g/cm³, more preferably between 5.2 g/cm³ and 5.4 g/cm³, the density being determined before the casting of the second metal matrix according to ISO 3369:2006;
the porosity of the ceramic-metal composite granules is lower than 5 vol %, preferably lower than 3 vol % and most preferably lower than 2 vol % and even lower than 0.5 vol %;
the embedded ceramic-metal composite granules have an average particle size d₅₀ between 0.5 and 10 mm, preferably 1 and 5 mm;
the embedded titanium carbide particles in the first metal matrix have an average particle size d₅₀ between 0.1 and 50 μm, preferably 1 and 20 μm;
the embedded micrometric carbide particles selected from the group consisting of tungsten carbide, vanadium carbide, molybdenum carbide, titanium carbide, niobium carbide, hafnium carbide and zirconium carbide or mixtures thereof in the second metal matrix have an average particle size d₅₀ between 0.1 and 50 μm, preferably 0.5 and 10 μm, the average particle size of the embedded carbide particles in the second metal matrix being determined by the linear-intercept method according to ISO 4499-3:2016.
the first metal matrix is selected from the group consisting of ferro-based alloy, ferromanganese-based alloy, ferrochromium-based alloy and nickel-based alloy, the composition of said ferro-based alloys being different from the composition of the ferrous cast alloys representing the second metal matrix;
the second metal matrix comprises ferrous alloy, in particular high chromium white cast iron or steel.

The present disclosure further discloses a method for the manufacturing of a ceramic-metal composite granules comprising the steps of:
grinding powder compositions comprising titanium carbide particles, titanium nitride particles, titanium carbo-nitride particles, or mixtures thereof and metallic particles of the first metal matrix in the presence of an oxidization preventing solvent such as alcohol or heptane to reach an average particle size d₅₀ between 1 and 20 μm, preferably between 1 and 10 μm;
mixing 1 to 10%, preferably 1 to 6% of paraffinic wax or solid lubricant such as Ca/Zn stearates to the powder composition;
removing the solvent by vacuum drying to obtain an agglomerated powder;
compacting the agglomerated powder into strips, sheets or rods;
crushing the strips, sheets or rods to particles of ceramic-metal composite until an average particle size d₅₀ between 0.05 and 10 mm, preferably between 0.1 and 5 mm;
sintering the granules at high temperature in a vacuum or argon atmosphere.

The present disclosure further discloses a method for the manufacturing of the three-dimensionally interconnected network of periodically alternating millimetric ceramic-metal composite granules with millimetric interstices, the granules being coated with carbide-forming metal powder, the method comprising the following steps:
mixing the ceramic-metal composite granules obtained according to the present disclosure with about 1 to 8 wt %, preferably 2 to 6 wt % of organic glue;
adding 5 to 20 wt % (related to the atomic weight of the metal) of carbide-forming metallic powders to the granules obtained in the previous step, the carbide-forming metallic powders being selected from the group consisting of tungsten, vanadium, molybdenum, titanium, niobium, hafnium and zirconium or mixtures thereof, the carbide-forming powder having an average particle size d₅₀ between 10 and 500 μm.-pouring and compacting the mix in a first mold;
curing the organic glue;
demolding the dried mix and obtaining the three-dimensionally interconnected network of periodically alternating millimetric ceramic-metal composite granules with millimetric interstices, said granules being coated/covered with the above-mentioned metals able to form metal carbides in situ to be used as reinforcement in the part exposed to wear of the hierarchical wear component.

The present disclosure further discloses a method for the manufacturing of a hierarchical composite cast wear part comprising the following steps:
positioning the three-dimensionally interconnected network of millimetric ceramic-metal composite granules coated with carbide-forming metal powder, said granules periodically alternating with millimetric interstices, in the part of the volume of a first mold of the hierarchical composite cast wear component to be reinforced;
pouring a second metal matrix into the second mold, and simultaneously infiltrating the millimetric interstices of the three-dimensionally interconnected network and forming additional carbides in the interstices via an in-situ reaction with the metals able to form carbides;
demolding the hierarchical composite cast wear component.

The present disclosure further discloses a hierarchical composite cast wear component obtained by the method of the present disclosure.

### BRIEF DESCRIPTION OF THE DRAWINGS

FIG. 1 shows the anvil ring of a milling machine in which the tests were carried out for the present disclosure.

FIG. 2 represents an individual anvil of the anvil ring of FIG. 1.

FIG. 3 represents a worn individual anvil.

FIG. 4 is a schematic representation of the positioning of the reinforcement structure in the part most exposed to wear of the individual anvil.

FIG. 5 represents a global view of the reinforcement structure defined as the three-dimensionally interconnected network of periodically alternating millimetric ceramic-metal composite granules with millimetric interstices, said granules being coated with metal particles able to form metal carbides in situ.

FIGS. 6 and 7 represent a magnification view of the reinforcement structure of FIG. 5 showing the presence of carbide forming metallic particles at the surface of TiC granules (FIG. 7=optical microscope picture) and FIG. 7a showing on a SEM picture a “clean” aggregate of ceramic metal composite grains without any carbide-forming metal particles on the surface. Instead, FIG. 7b shows on a SEM picture coated ceramic metal composite grains with carbide-forming metal particles on the surface.

FIG. 8 represents a sectional detailed view of the cast wear component with the millimetric ceramic-metal composite granules inclusion with interstices filled by the second metal matrix (the cast metal matrix).

FIG. 9 represents the interface between the composite TiC-metal granules and the second metal matrix showing microscopic spheroidal TiC particles (black) embedded in the first metal matrix, the binder of the TiC particles and microscopic spheroidal NbC particles (white) embedded and formed in situ in the second metal matrix filling the interstices. The picture is a high magnification of the interface between TiC granules and the second metal matrix represented in FIG. 8.

FIG. 10 is a schematic representation of the concept of the present disclosure based on a scale difference between the embedded micrometric TiC particles in a first metal matrix forming millimetric granules of ceramic-metal composite integrated in the form of a three dimensional network in the reinforced part of the wear component. Additional carbides that have been formed in situ from carbide-forming metal particles are represented in the interstices between the millimetric granules.

FIG. 11 is a representation of a cross section of a sample comprising granules, this cross section being used in the method to obtain the ceramic-metal granule average particle size (as explained below).

FIG. 12 is a schematic representation of the method to measure the Feret diameter (with minimum and maximum Feret diameters). These Feret diameters being used in the method to obtain the ceramic-metal granule average particle size (as explained below).

### DETAILED DESCRIPTION

The present disclosure relates to a hierarchical composite wear component produced by conventional casting. It consists of a metal matrix comprising a particular reinforcement structure comprising dense (low porosity<5%), irregular ceramic-metal composite granules with a millimetric size average of 0.5 to 10 mm, preferably 0.8 to 6 mm, more preferably 1 to 4 mm, even more preferably 1 to 3 mm.

It has been observed that the use of additional metallic powders associated to the ceramic metal granules allows a supplementary increase of the carbide concentration via a carbon source (organic glue) within the interstices once filled by the cast metal.

The aim of the present disclosure is to increase the carbide concentration even within the interstices filled by the cast metal (second metal matrix). Even a small amount of additional micrometric carbide particles in the interstices has a positive influence on the combined wear/impact resistance of the wear part. Therefore, the hierarchical composite according to the present disclosure comprises in its reinforced part not only millimetric interstices periodically alternating with the millimetric ceramic-metal composite granules, but also at least 3 vol % of micrometric carbide particles, other than chromium carbide naturally present in high chromium white cast iron, located in the interstices between the millimetric granules obtained via the presence of carbide-forming metal powders (Ti,Nb,V,W,Mo,Zr, . . . ) and a carbon source coming from the second metal matrix or from the organic glue used to compact the millimetric grains of cermet powders.

Ceramic-metal composites are composed of ceramic particles bonded by a metallic binder, called in the present disclosure the first metal matrix. Additional micrometric carbide particles are also provided in the second metal matrix (cast metal), in the millimetric interstices between the millimetric ceramic-metal composite granules.

For wear applications, the ceramic provides the high wear resistance, while the metal improves, amongst other properties, the toughness. TIC ceramic-metal composites comprise titanium carbide micrometric spheroidal particles (52 to 95 vol % of the granules, preferably 61 to 90 vol %, more preferably 70 to 90 vol %, size from 0.1 to 50 μm, preferably 0.5 to 20 μm, more preferably 1 to 10 μm) bonded by a metallic phase (first metal matrix) that can for example be Fe-, Ni- or Mo-based alloys. A ferrous alloy, preferably high chromium white cast iron or steel (second metal matrix), is cast in the mold and infiltrates the interstices of said reinforcement structure.

In the present disclosure, the expression TIC, or other metallic carbides, should not be understood in a strict stoichiometric chemical meaning but as Titanium Carbide in its crystallographic structure. Titanium carbide possesses a wide composition range with C/Ti stoichiometry varying from 0.47 to 1, a C/Ti stoichiometry higher than 0.8 being preferred.

The volume content of ceramic-metal composite granules in the insert building the reinforced volume of the wear part (hollow parts or recesses, if any, excluded) is typically comprised between 45 and 65 vol %, preferably between 50 and 60 vol %, leading to average TiC concentrations in the reinforced volume comprised between 23 and 62 vol %, preferably between 28 and 60 vol %, more preferably between 30 and 55 vol %.

The millimetric interstices periodically alternating with the millimetric ceramic-metal composite granules comprise at least 3 vol %, preferably at least 5 vol % of micrometric carbide particles selected from the group consisting of tungsten carbide, vanadium carbide, molybdenum carbide, titanium carbide, niobium carbide, hafnium carbide and zirconium carbide or mixtures thereof.

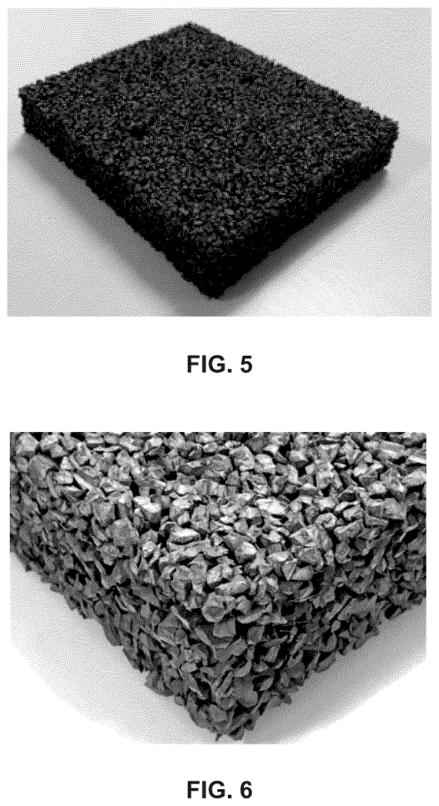

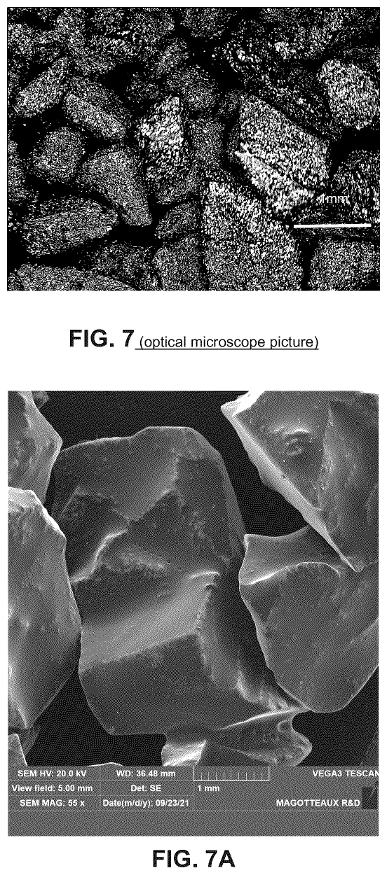

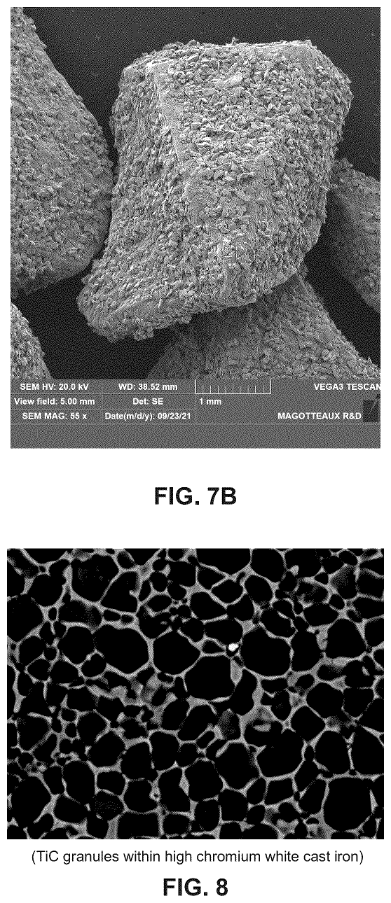

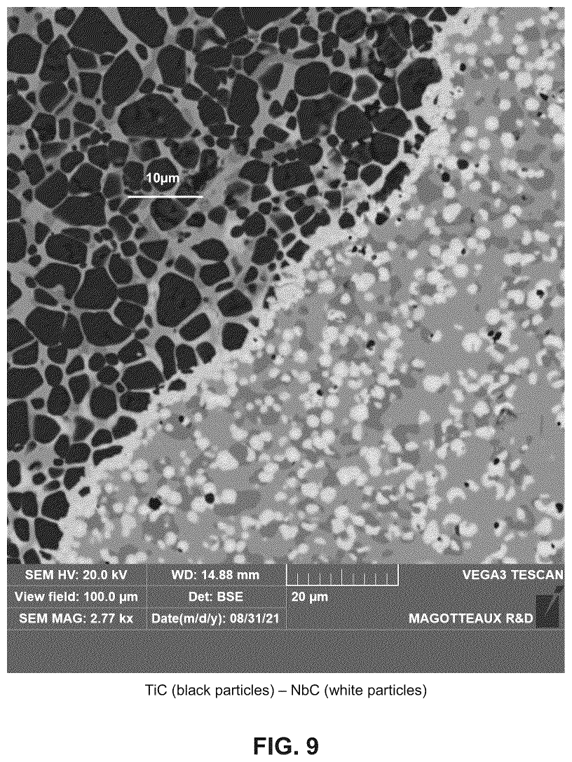

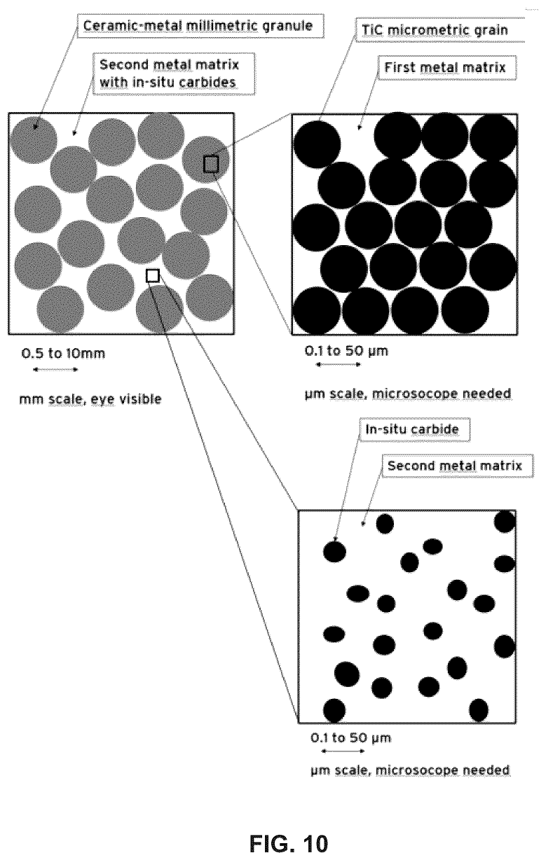

The hierarchical reinforced part of the wear component is produced from an aggregation of irregular millimetric ceramic-metal composite granules having an average size between approximately 0.5 and 10 mm, preferably 0.8 and 6 mm, more preferably between 1 and 4 mm, even more preferably between 1 and 3 mm (see FIGS. 5,6 and 7).

The ceramic-metal composite granules coated/covered with a carbide forming metallic powder are generally aggregated into a desired tridimensional shape with well-known sodium or potassium or silicate glass inorganic adhesive, but in the present disclosure, organic glues like polyurethane or phenolic resins are preferred as additional carbon source for the carbide-forming metals. The aggregate can be placed in a container or behind a barrier. The desired shape forms an open structure formed of a three-dimensionally interconnected network of metal powder-coated agglomerated/aggregated ceramic-metal composite granules bound by a binding agent or maintained in shape by a container or barrier, wherein the packing of the granules leaves millimetric open interstices between the granules, the millimetric interstices being fillable by a liquid cast metal (second metal matrix). This agglomerate is placed or located in a mold prior to the pouring of the ferrous alloy to form the reinforced part of the wear component. The liquid metal is then poured into the mold and the liquid metal fills the open interstices between the granules. Millimetric interstices should be understood as interstices of 0.1 to 5 mm, preferably 0.5 to 3 mm, depending on the compaction of the reinforcement structure and the size of the granules.

The ceramic-metal composite granules are usually manufactured in a conventional way, by powder metallurgy, shaping a blend of ceramic and metallic powders of appropriate size distribution followed by a liquid-phase sintering.

Typically, the powders are 0.1-50 μm in diameter and comprise TIC as the main component and 5 to 48 percent of a metallic binder which can be an individual constituent powder or already alloyed powders (first metal matrix). The powders are first mixed and/or ground (depending on the initial powder size) in a ball mill, dry or wet grinding (with alcohol or hexane, for instance to avoid the metallic powder oxidation). Some organic processing aids may be added for dispersion or shaping aid purposes. A drying step may be needed in case of wet grinding. This can be done for example by vacuum drying or spray drying. The shaping is usually performed by cold uniaxial, isostatic pressing or injection molding or any other shaping methods to form a strip, a rod or a sheet.

Stripes of sheets, for instance, can be crushed to grains and possibly sieved, until an average particle size d₅₀ between 0.05 and 10 mm, preferably between 0.1 and 5 mm is reached. It can be an advantage to achieve irregular granule shapes free of easy pull out orientation (granules very well mechanically retained in the cast metal).

The granules are then sintered at a suitable temperature under low or high vacuum, inert gas, hydrogen or combinations thereof. During liquid-phase sintering, particle rearrangement occurs, driven by capillarity forces. The sintered granules are then mixed with organic glue and with carbide forming metallic powders. The carbide-forming metallic powders are selected from the group consisting of tungsten, vanadium, molybdenum, titanium, niobium, hafnium and zirconium or mixtures thereof, the carbide-forming powder having an average particle size d₅₀ between 20 and 500 μm. The mix comprises 1 to 20 vol %, preferably 5 to 15 vol %, of carbide-forming metallic powders and 80 to 99%, preferably 85 to 95% by volume, of ceramic-metal composite granules.

The cast alloy (second metal matrix) embedding the ceramic-metal composite granules of the wear component is preferably a ferrous alloy (high chromium white cast iron, steel, manganese steel, . . . ) or a nickel or molybdenum alloy. This alloy can be chosen in order to achieve locally optimized properties depending on the final stress on the wear part (for example manganese steel will provide high impact resistance, high-chromium white cast iron will provide higher wear resistance, nickel alloy will provide superior heat and corrosion resistance, etc.).

The carbide-forming metallic powder is chosen in order to achieve locally optimized properties depending on the final stress on the wear part. The choice of the carbide-forming metal depends on various criteria such as for instance a low solubility (Zr,Hf) for larger crystals or availability and average solubility (Ti, W, Mo) and price.

### Advantages

The present disclosure allows to obtain, within a conventional casting, a concentration of TiC particles that can be very high in the ceramic-metal composite granules (52 to 95% in volume), with no risk of defects inside the cast structure (gas holes, cracks, heterogeneities, . . . ) or uncontrolled and dangerous reactions and projections as for in-situ formation of TiC in a self-propagating exothermic reaction of large amounts of reactive materials (SHS, see above). In the present disclosure, high average concentrations of TiC can be reached in the reinforced volume of the wear part, via low porosity of the ceramic-metal composite granules. Values up to about 62 vol % can be reached depending on the compaction/piling of the ceramic-metal composite granules in the reinforced volume.

The use of additional metallic powders associated with the ceramic-metal granules allows a supplementary increase of the carbide concentration within the interstices once filled by the cast metal. The carbide concentration within the interstices is complementary to the high concentration of TiC within the ceramic-metal composite granules but not too high to maintain the properties of an alternating hard and ductile structure.

The hierarchical wear component of the present disclosure is substantially free of porosity and cracks, resulting in better mechanical and wear properties.

The size of the particles of titanium carbide and the ceramic-metal composite granules (TiC+binder) of the present disclosure can be extensively controlled during the manufacturing process (choice of raw materials, grinding, shaping process and sintering conditions). Using sintered, millimetric TIC-based ceramic-metal composite granules made by well-known powder metallurgy allows the control of grain size and porosity, the use of various compositions of metallic alloys as first metal matrix, high concentrations of TiC, easy shaping of inserts without extensive need of man work, and good internal health of grains after the pouring even in high thermal shock conditions.

### Manufacturing of the Ceramic-Metal Composite Granules:

The grinding and/or the mixing of the inorganic TiC powder (52 to 95 vol %, preferably 61 to 90 vol %, more preferably 70 to 90 vol %) and metallic powders as first metallic matrix (5 to 48 vol %, preferably 10 to 39 vol %, more preferably 10 to 30 vol %) is carried out, as mentioned above, in a ball mill with a liquid that can be water or alcohol, depending on metallic binder sensitivity to oxidation. Various additives (antioxidant, dispersing agents, binder, plasticizer, lubricant, wax for pressing, . . . ) can also be added for various purposes.

Once the desired average particle size is reached (usually below 20 μm, preferably below 10 μm, more preferably below 5 μm), the slurry is dried (by vacuum drying or spray drying) to achieve agglomerates of powder containing the organic aids.

The agglomerated powder is introduced in a granulation apparatus through a hopper. This machine comprises two rolls under pressure, through which the powder is passed and compacted. At the outlet, a continuous strip (sheet) of compressed material is obtained, which is then crushed in order to obtain the ceramic-metal composite granules. These granules are then sifted to the desired grain size. The non-desired granule size fractions are recycled at will. The obtained granules have usually 40 to 70% relative density (depending on compaction level powder characteristics and blend composition).

It is also possible to adjust the size distribution of the granules as well as their shape to a more or less cubic or flat shape, depending on the crushing method (impact crushing will deliver more cubic granules, while compression crushing will give more flat granules). The obtained granules globally have a size that will provide, after sintering, granules between 0.5 to 10 mm, preferably 0.8 to 6 mm, more preferably from 1 to 4 mm, even more preferably from 1 to 3 mm. Granules can also be obtained by classical, uniaxial pressing or granulating of the powder blend directly as grains or into much bigger parts that will be further crushed into granules, before or after sintering. Finally, liquid phase sintering can be performed in a furnace at a temperature of 1000-1600° C. for several minutes or hours, under vacuum, N₂, Ar, H₂ or mixtures, depending on the metallic phase (type and quantity of the binder) until the desired porosity is reached, preferably below 5%, more preferably less than 3%, most preferably less than 2%.

The obtained sintered granules are then mixed with organic glue and with carbide-forming metallic powders. The carbide-forming metallic powders are selected from the group consisting of tungsten, vanadium, molybdenum, titanium, niobium, hafnium and zirconium or mixtures thereof, the carbide-forming powder having an average particle size d₅₀ between 20 and 500 μm. The mix comprises 3 to 20%, preferably 5 to 15 vol % of carbide-forming metallic powders and 80 to 97%, preferably 85 to 95% by volume of the obtained ceramic-metal composite particles.

### Realization of the Three Dimensional Reinforcement Structure (Core)

As mentioned above, the ceramic-metal composite granules coated by carbide-forming metallic powder are agglomerated either by means of an adhesive, or by confining them in a container or by any other means. The proportion of the adhesive does not exceed 10 wt % relative to the total weight of the granules and is preferably between 2 and 7 wt %. This adhesive is preferably an organic adhesive based on a polyurethane or phenolic resin.

The ceramic-metal composite granules with low porosity are preferably mixed with an organic adhesive and the core is then hardened and can be demoulded. Depending on granule shape, size distribution, vibration during the positioning of the granules or tapping the granules bed while making the core, the core usually comprises 30 to 70 vol %, preferably 40 to 60 vol % of dense granules and 70 to 30 vol %, preferably 60 to 40 vol % of voids (millimetric interstices) in a 3D interconnected network.

### Casting of the Wear Part

The core (three-dimensional interconnected network reinforcement structure) is positioned and fixed with screws or any other available means in the mold portion of the wear part to be reinforced. Hot liquid ferrous alloy, preferably high chromium white cast iron or steel, is then poured into the mold.

The hot, liquid, ferrous alloy thus only fills the millimetric interstices between the granules of the core.

Due to the limited amount of metal powder forming metal carbide, there is no excessive SHS reaction (exothermic reaction or gas release) during the pouring, and the cast metal will infiltrate the interstices (millimetric spaces between the granules) but will hardly infiltrate the ceramic-metal composite granules since they are not porous, but the metallic powders will form micrometric carbide particles in the interstices where the second metal matrix is present until complete cooling of the wear part.

### Measurement Methods

For porosity, granule or particle size measurements, a sample is prepared for metallographic examination, which is free from grinding and polishing marks. Care must be taken to avoid tearing out of particles that can lead to a misleading evaluation of porosity. Guidelines for the specimen preparation can be found in ISO 4499-1:2020 and ISO 4499-3:2016, 8.1 and 8.2.

### Porosity Determination:

The volume fraction of porosity of the free granules can be calculated from the measured density and the theoretical density of the granules.

The volume fraction of porosity of the granules embedded in the metal matrix is measured according to ISO 13383-2:2012. Although this standard is applying specifically to fine ceramics, the described method to measure the volume fraction of porosity can also be applied to other materials. As the samples here are not pure fine ceramics but hard metal composites, sample preparation should be done according to ISO 4499-1:2020 and ISO 4499-3:2016, 8.1 and 8.2. Etching is not necessary for porosity measurement, but can be performed anyway as it will not change the result of measurement.

### Titanium Carbide Average Particle Size:

The average particles size of the embedded titanium carbide particles is calculated by the linear-intercept method according to ISO 4499-3:2016. Five images from the microstructure of five different granules are taken with an optical or electronic microscope at a known magnification such that there are 10 to 20 titanium carbide particles across the field of view. Four linear-intercept lines are drawn across each calibrated image so that no individual particle is crossed more than once by a line.

Where a line intercepts a particle of titanium carbide, the length of the line (lᵢ) is measured using a calibrated rule (where i=1,2,3 . . . n for the 1^{st}, 2^{nd}, 3^{rd}, . . . , nth grains). Incomplete particles touching the edges of the image must be ignored. At least 200 particles must be counted.

The mean-linear-intercept particle size is defined as:

$${d}_{x} = \frac{\sum {l}_{i}}{n}$$

### Ceramic-Metal Granule Average Particle Size:

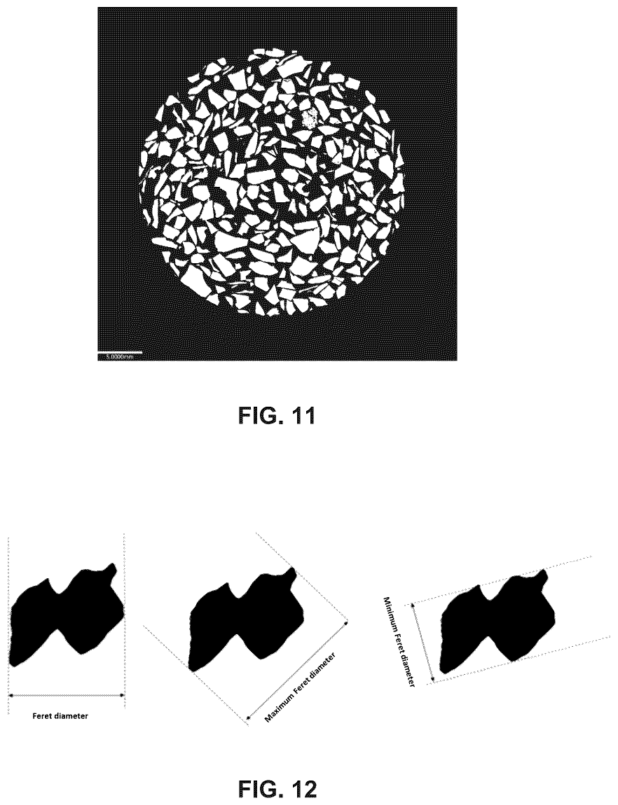

A photomicrographic panorama is made by stitching such that there are at least 250 ceramic-metal granules across the field of view of the polished cross section of the sample. The process of combining a series of digital images of different parts of a subject into a panoramic view of the whole subject that retains good definition using a computer program and optical microscope (for example a general image field panorama obtained by an Alicona Infinite Focus) is part of the state of the art. An appropriate thresholding allows to segment grayscale image into features of interest (the granules) and background (see FIG. 11). If the thresholding is inconsistent due to poor image quality, a manual stage involving drawing by hand the granules, the scale bar if present, and the image border on a tracing paper and then scanning the tracing paper is used.

Feret diameter, which is the distance between two tangents placed perpendicular to the measuring direction, is measured in all direction for each granule by an image analysis software (ImageJ for example). An example is given in FIG. 12.

Minimum and maximum Feret diameter of each granule of the image are determined. Minimum Feret diameter is the shortest Feret diameter out of the measured set of Feret diameters. Maximum Feret diameter is the longest Feret diameter out of the measured set of Feret diameters. Granules touching the edges of the image must be ignored. The mean value of the minimum and maximum Feret diameters of each granule is taken as the equivalent diameter x. The volume size distribution q₃(x) of the granules is then calculated based on spheres of diameter x. D₅₀ of the granules is to be understood as the volume weighted mean size x_{1,3} according to ISO 9276-2:2014.

### Ceramic-Metal Granule Average Particle Size During Manufacturing of the Granules:

Granule size is measured by dynamic image analysis according to ISO 13322-2:2006 by mean of a Camsizer from Retsch. The particle diameter used for size distribution is X_{c min}, which is the shortest chord measured in the set of maximum chords of a particle projection (for a result close to screening/sieving).

Granule d₅₀ is the volume weighted mean size of the volume distribution based on X_{c min}.

### Particle Size Measurement of the Powder During the Grinding:

The particle size of the powder during the grinding is measured by laser diffraction with the MIE theory according to guidelines given in ISO 13320:2020 by mean of a Mastersizer 2000 from Malvern. Refractive index for TIC is set to 3 and the absorption to 1. Obscuration must be in the range of 10 to 15% and the weighted residual must be less than 1%.

### Density Measurement of the Sintered Granules:

The determination of the density of sintered granules is performed with water according to ISO 3369:2006. For granules without any open porosity, a gas displacement pycnometer (like the AccuPyc II 1345 Pycnometer from Micromeritics) can also be used, giving substantially the same density value.

### Determination of the Additional Carbide Concentration in the Interstices Between the Granules

The additional carbide concentration in the interstices is determined according to ISO 13383-2:2012. This method specifies a manual method of making measurements for the determination of the volume fraction in fine ceramics using micrographs of polished and etched sections, overlaying a square grid of lines, and counting the number of intersections lying over each ceramic phase.

### Reduction to Practice—Anvil Wear Part

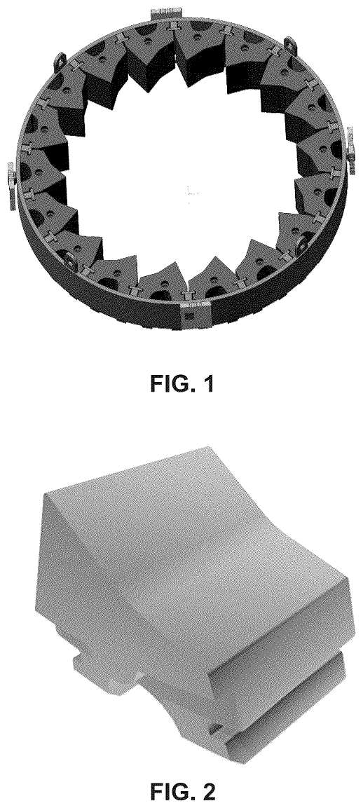

Anvil wear parts used in a vertical shaft impactor have been made according to the present disclosure. The reinforced volume of the wear parts comprises different average volume percentages of TiC from about 30 up to 50 vol % (FIG. 1 to FIG. 3).

They were compared to a wear part made according to U.S. Pat. No. 8,999,518 B2, example 4 of the present disclosure (with a global volume percentage of TiC of about 32 vol % in the reinforced volume). The reason for this comparison is that example 4 is a typical “in-situ” composition (Ti+C and moderator in a self-propagating reaction) that can be managed with care in plants, in spite of the fact that it is still creating flames, gases and some hot liquid metal projection during the pouring.

The anvil wear parts of the present disclosure were also compared to a wear part made with different ceramic reinforcements but with an identical metallic matrix.

### Preparation of the TiC Granules of Two Different Types:

TiC powder of a size less than 325 mesh (44 μm) is mixed with one or several alloyed or pure individual elements to reach the compositions of Table 1.

The powder is then ground in a ball mill with processing aids avoiding oxidation of the metals, such as alcohols, for 24h to reach an average particle size of 3 μm.

TABLE 1

| | Granule type 1 | Granule type 2 |
|---|---|---|
| | High chromium | Manganese |
| | white cast iron | steel |
| wt % | binder | binder |
| TIC | 80 | 80 |
| C | 0.7 | |
| Mn | 0.2 | 2.8 |
| Cr | 5.0 | |
| Ni | 0.0 | 1.1 |
| Mo | 0.3 | |
| Si | 0.1 | |
| Fe | 13.7 | 16.1 |
| alloy density | 7.5 | 7.87 |
| vol % TiC | 86% | 86% |

The anti-oxidation solvent is removed by a vacuum-dryer with rotating blades and about 2 wt % of paraffin wax is then added and mixed with the powder blend. The obtained agglomerated powder is then sifted through a 100 μm sieve. Strips of 70% of the theoretical density of the inorganic/metallic powder mixtures are made by compaction between the rotating rolls of a roller compactor granulator with about 200 bar pressure. The strips are then crushed to irregular granules by forcing them through a sieve with appropriate mesh size. After crushing, the granules are sifted so as to obtain a dimension between 1.4 and 4 mm. These irregular porous granules are then sintered at high temperature of about 1300° C. to 1500° C. for 2 hours in a vacuum furnace with about 20 mbar partial pressure of argon until a minimal porosity (<0,5 vol %) is reached.

The sintered granules type 2 with low porosity are then mixed with about 2 wt % of an organic bi-component polyurethane glue.

Metallic powders of the carbide-forming element are then added to the mix containing granules of type 2, niobium powder of a size less than 325 mesh for example 1 and zirconium powder of less than 325 mesh for example 2. The fine metallic powder particles adhere to the polyurethane on the surface of the millimetric granules and form a coating on the surface.

The mixes are poured into a silicone mold (vibrations can be applied to ease the packing and be sure that all the granules are correctly packed) of the desired shape of 100×30×150 mm. After drying at 100° C. for several hours in a stove or gaseous hardening with an amine gas for polyurethane binder, the cores are hard enough and can be demolded.

This interconnected network of metal-coated granules, as represented in FIGS. 5 and 6, comprise about 55 vol % of dense granules coated with fine powder (45 vol % of voids/millimetric interstices between the coated granules). Each cores/three dimensional reinforcement structures are positioned in the molds in the portion of the wear parts to be reinforced (as represented in FIG. 4). Hot liquid high chromium white cast iron or carbon steel of the compositions given in Table 2 is then poured into the molds.

TABLE 2

| | C | Mn | Cr | Ni | Mo | Si | Cu | Fe | Pouring metal |
|---|---|---|---|---|---|---|---|---|---|
| wt % | 3.3 | 1.2 | 25 | 0 | 1.5 | 0.5 | 0 | balance | High chromium |
| | | | | | | | | | white cast iron |
| wt % | 0.4 | 0.9 | 3.1 | 1.1 | 0.6 | 0.8 | 0.6 | balance | Carbon Steel |

During the pouring process, the hot liquid metal fills all the millimetric interstices between the granules of the interconnected network, said interstices representing 45% of the total volume of the reinforced portion. During the casting, the polyurethane glue is carbonized and the metallic powder additive reacts with the carbon of the melt and/or of the carbonized polyurethane, as carbon source, to form additional carbide particles. After pouring, in the reinforced portion, a composite is formed by 55 vol % with a high concentration of about 86 vol % titanium carbide particles bonded by the first metal matrix and 45 vol % of a second metal matrix with an average additional concentration of about 8 vol % of additional carbide particles of niobium or zirconium (see Table 3 below). The global volume content of carbides, other than chromium carbide naturally present in the chromium steel, obtained in the reinforced macro-microstructure of the wear part is then of about 47 vol %.

### Examples

In the following examples, the dimension of the reinforced area is 150×100×30 mm, leading to a volume of 450 cm³. The reinforced portion has a filling proportion of 55 vol % and the volume of the metal-ceramic granules represents therefore 248 cm³.

### 5 Below are Disclosed the Composition and Properties of the Three-Dimensionally Interconnected Network of Periodically Alternating Millimetric Ceramic-Metal Composite Granules

| | | | Compa. | Compa. | Comparative |
|---|---|---|---|---|---|
| | example | example | Example | Example | example |
| | 1 | 2 | 1 | 2 | 3 (M1 = M2) |
| Granule type | Granule | Granule | Granule | example | Granule |
| | type | type | type | 4 of | type 1 |
| | 2 | 2 | 2 | US 518 | |
| Granules relative density | 99.6% | 99.6% | 99.6% | 85.0% | 99.6% |
| (%) | | | | | |
| Granules porosity (%) | 0.4% | 0.4% | 0.4% | 15.0% | 0.4% |
| Granule theoretical | 5.33 | 5.33 | 5.33 | 4.25 | 5.29 |
| density | | | | | |
| Density of the granules | 5.31 | 5.31 | 5.31 | 3.61 | 5.27 |
| (g/cm³) | | | | | |
| Granules quantity (g) | 1314 | 1314 | 1314 | 894 | 1304 |
| Glue quantity (g) | 26 | 26 | 26 | | 26 |
| Nb powder-325 mesh (g) | 106 | | | | |
| Zr powder-325 mesh (g) | | 92 | | | |
| Calculated TiC content | 86% | 86% | 86% | Ti + C (*) | 86% |
| in the granules (vol %) | | | | | |
| (*) Ti + C not reacted | | | | | |
| Wear part | | | | | |
| TiC content in the | 86% | 86% | 86% | 57% | 86% |
| granules (vol %) | | | | | |
| TiC content in the | 47% | 47% | 47% | 32% | 47% |
| reinforced portion (vol %) | | | | | |
| Additional carbide in the | 8% | 8% | | | |
| second metal matrix | | | | | |
| (cast alloy) (vol %) | | | | | |
| Additional carbide | 3% | 3% | 0% | 0% | 0% |
| content in the reinforced | | | | | |
| portion (vol %) | | | | | |
| Porosity in the reinforced | 0.4% | 0.4% | 0.4% | 3% | 0.4% |
| portion (vol %) | | | | | |
| Performance Index | 1.30 | 1.25 | 1.20 | 1.00 | 1.10 |

Evaluation of the concentration of the additional carbide in the second metal matrix (vol %) by calculation for a reinforced volume of 450 cm³ (V_{reinforced}) and 1314 g of granules (W_{granules}). The theoretical density of the granules is 5,33 g/cm³, the porosity is 0.4 vol % and the global granule volume is 247 cm³ with an interstice volume of 202.5 cm³.

| | | | Example | Example |
|---|---|---|---|---|
| | | Formula | 1 | 2 |
| Carbide-forming metal | W_{Me} | | 106 | 92 |
| wgt (g) | | | | |
| Carbide metal forming | | | Niobium | Zirconium |
| M carbide forming | M_{Me} | | 92.9 | 91.2 |
| metal (g/mol) | | | | |
| M carbon (g/mol) | M_{c} | | 12.0107 | 12.0107 |
| M metal carbide | M_{Me} | | 104.9 | 103.2 |
| (g/mol) | _{carbide} | | | |
| Metal carbide formed | W_{Me} | W_{Me} × | 119.7 | 104.1 |
| wt (g) | _{carbide} | M_{Me carbide}/ | | |
| | | M_{Me} | | |
| Metal carbide density | d_{Me} | | 7.8 | 6.7 |
| (g · cm⁻³) | _{carbide} | | | |
| Metal carbide volume | V_{Me} | W_{Me carbide}/ | 15 | 15 |
| (cm³) | _{carbide} | d_{Me carbide} | | |
| additional carbide | | | | |
| vol % | | | | |
| in interstices | | V_{Me carbide}/ | 8% | 8% |
| | | V_{interstices} | | |
| In reinforcement | | V_{Me carbide}/ | 3% | 3% |
| | | V_{reinforced} | | |

Comparison with Prior Art

The wear parts according to the present disclosure are compared to the wear part obtained as in example 4 of U.S. Pat. No. 8,999,518 B2 (see comparative example 2 in the present disclosure). The anvil wear parts of the present disclosure are also compared to a wear part made with ceramic-metal granules, the binder of which is identical to the cast alloy (see comparative example 3).

The anvil ring of the milling machine in which these tests were carried out is illustrated in FIG. 1.

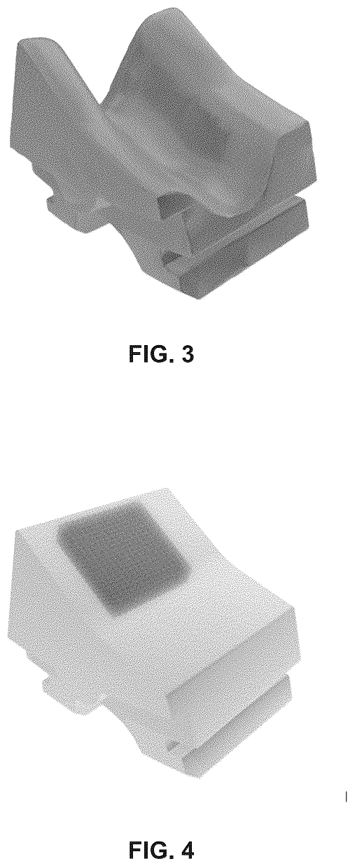

In this machine, the inventor alternately placed an anvil comprising an insert (as represented in FIGS. 2 and 3) according to the present disclosure surrounded on either side by a reinforced anvil according to the state of the art of comparative examples 2 and 3 to evaluate the wear under the exact same conditions. Material to be crushed is projected at high speed onto the working face of the anvils (an individual anvil before wear is represented in FIG. 2). During crushing, the working face is worn. The worn anvil is represented in FIG. 3.

### Calculation of the Performance Index

For each anvil, the weight loss is measured by weighting each anvil before and after use.

weight loss=(final weight−initial weight)/initial weight

A performance index is defined as below, the weight loss of reference being the average weight loss of example 4 of U.S. Pat. No. 8,999,518 B2, (herein comparative example 2) anvil on each side of the test anvil.

PI=weight loss of reference anvil/weight loss of test anvil

Performance index above 1 means that the test anvil is less worn than the reference anvil, below 1 means that the test anvil is more worn than the reference anvil.
The performance index (PI) of the reinforced anvil according to comparative example 3 of this invention (using ceramic-metal composite granules containing 86 vol % by (80 wt %) of titanium carbide bound by a similar metallic matrix as cast alloy) is: 1.10. The higher performance than comparative example 2 (example 4 of U.S. Pat. No. 8,999,518 B2) can be explained by lower defects such as cracks and porosity in the part and much higher local and global volume concentration of titanium carbide in the granules and reinforced portion.
The performance index (PI) of the reinforced anvil according to comparative example 1 of this invention (using ceramic-metal composite granule containing 86 vol % by (80 wt %) of titanium carbide bound by a different metallic matrix (steel) as cast alloy) is: 1.20. The higher performance than comparative example 3 can be explained by higher toughness of the granules due to the tough steel matrix vs the more brittle high chromium white cast iron matrix.
Performance index (PI) of the reinforced anvil according to example 1 of this invention (using ceramic-metal composite granule containing 86 vol % by (80 wt %) of titanium carbide) and 8 vol % of additional carbide in the cast alloy formed by the additional niobium metallic powder in the insert prior to pouring: is: 1.30. The higher performance than example 2 can be explained by the niobium carbides present in the second metal matrix being more performant than zirconium carbide in this particular conditions.
Performance index (PI) of the reinforced anvil according to example 2 of this invention (using ceramic-metal composite granule containing 86 vol % by (80 wt %) of titanium carbide) and 8 vol % of additional carbide in the cast alloy formed by the additional zirconium metallic powder in the insert prior to pouring is: 1.25. The higher performance than comparative example 1 can be explained by the additional carbides in the second metal matrix.

### Composite Density Related to the Density of the Compounds (Titanium Carbide and Alloys)

The following tables illustrates the density of the composite as a function of vol % of TiC and vol % of porosity (for iron-based alloys).

| | Density |
|---|---|
| | (g/cm³) |
| Titanium carbide | 4.93 |
| High chromium | 7.5 |
| white cast iron | |
| Ferrous alloy | 7.87 |

| Composite density | | | | | |
|---|---|---|---|---|---|
| with ferrous alloy | | Porosity (vol %) | | | |
| (g/cm³) | | 5% | 3% | 2% | 0.10% |
| Titanium | 52% | 6.02 | 6.15 | 6.21 | 6.33 |
| carbide | 61% | 5.77 | 5.89 | 5.96 | 6.07 |
| content | 70% | 5.52 | 5.64 | 5.70 | 5.81 |
| (vol %) | 85% | 5.10 | 5.21 | 5.26 | 5.37 |
| | 96% | 4.80 | 4.90 | 4.95 | 5.04 |
| | 99% | 4.71 | 4.81 | 4.86 | 4.95 |

### ADVANTAGES OF THE PRESENT DISCLOSURE

The present disclosure has the following advantages in comparison with the state of the art:
Better wear performance due to locally higher vol % of TiC in the granules (impossible to reach in practice with SHS technologies using large amounts of reactives as in the state of the art).
Better wear performance or mechanical properties of the wear part by tailoring the size and volume content of titanium carbide and the use of a metal phase binder (first metal matrix) such as high mechanical properties manganese steel in the TiC ceramic-metal composite granules combined to the cast alloy (second metal matrix) such as high chromium white iron for the wear part, the first metal matrix being different from the second metal matrix.
Better wear performance or mechanical properties of the wear part by tailoring the size and volume content of additional carbide in the second metal matrix.
Better wear performance or mechanical properties of the wear part due to lower porosity and/or lower crack defects, since few or no gas is generated during pouring.

1. A hierarchical composite wear component comprising:
a reinforced part and a non-reinforced part, the reinforced part comprising a three-dimensionally interconnected network of periodically alternating millimetric ceramic-metal composite granules with millimetric interstices, the ceramic-metal composite granules comprising at least 52 vol % of micrometric particles of titanium carbide embedded in a first metal matrix, the porosity of the ceramic-metal composite granules being lower than 5 vol %, the volume fraction of porosity of the granules embedded in the first metal matrix being determined according to ISO 13383-2:2012;
wherein the three-dimensionally interconnected network of ceramic-metal composite granules with millimetric interstices is embedded in a second metal matrix, and the volume content of ceramic-metal composite granules in the reinforced part is comprised between 45 and 65 vol %;
wherein the composition of the first metal matrix is substantially different from the composition of the second metal matrix;
wherein the second metal matrix comprises the ferrous cast alloy present in the millimetric interstices of the reinforced part, said millimetric interstices additionally comprising at least 1 vol % of micrometric carbide particles selected from the group consisting of tungsten carbide, vanadium carbide, molybdenum carbide, titanium carbide, niobium carbide, hafnium carbide and zirconium carbide, or mixtures thereof, the volume percentage of additional carbides in the second metal matrix being determined according to ISO 13383-2:2012.

2. The hierarchical composite wear component according to claim 1, wherein the embedded ceramic-metal composite granules have an average particle size d₅₀ between 0.5 and 10 mm, the average particle size being determined by the following steps:
taking a photomicrographic picture of a polished cross section of a sample capturing at least 250 ceramic-metal granules across the field of view;
measuring the Feret diameter of the granules;
calculating the volume size distribution of the granules;
calculating the d₅₀ of the granules according to ISO 9276-2:2014.

3. The hierarchical composite wear component according to claim 1, wherein the embedded titanium carbide particles in the first metal matrix have an average particle size d₅₀ between 0.1 and 50 μm, the average particle size of the embedded titanium carbide particles being determined by the linear-intercept method according to ISO 4499-3:2016.

4. The hierarchical composite wear component according to claim 1, wherein the embedded micrometric carbide particles in the second metal matrix have an average particle size d₅₀ between 0.1 and 50 μm, the average particle size of the embedded carbide particles in the second metal matrix being determined by the linear-intercept method according to ISO 4499-3:2016.

5. The hierarchical composite wear component according to claim 1, wherein the first metal matrix is selected from the group consisting of ferro-based alloy, ferromanganese-based alloy, ferrochromium-based alloy, and nickel-based alloy, the composition of said ferro-based alloys being substantially different from the composition of the ferrous cast alloys of claim 1.

6. The hierarchical composite wear component according to claim 1, wherein the second metal matrix comprises high chromium white iron or steel.

7. A method for the manufacturing of the hierarchical composite cast wear part of claim 1 comprising the steps of:
grinding powder compositions comprising titanium carbide particles, titanium nitride particles, titanium carbonitride particles, or mixtures thereof and metallic particles of the first metal matrix to reach an average particle size d₅₀ between 1 and 20 μm;
mixing 1 to 10% of agglomeration wax to the powder composition;
compacting the agglomerated powder into strips, sheets, or rods;
crushing the strips, sheets, or rods to particles of ceramic-metal composite until an average particle size d₅₀ between 0.05 and 10 mm is reached;
liquid phase sintering between 1000° C. and 1600° C. for several minutes or hours under vacuum, N₂, Ar, H₂ or mixtures thereof, of the particles of ceramic-metal composite into millimetric granules until a porosity below 5% is reached.
mixing the sintered ceramic-metal composite granules with about 1 to 8 wt % of organic glue;
mixing 1 to 20% by volume of carbide-forming metallic powders with 80 to 97% by volume of the obtained ceramic-metal composite particles in the previous step, the carbide-forming metallic powders being selected from the group consisting of tungsten, vanadium, molybdenum, titanium, niobium, hafnium, and zirconium or mixtures thereof, the carbide forming powder having an average particle size d₅₀ between 20 to 500 μm;
compacting the mix in a first mold;
drying the mix at appropriate temperature to cure or dry the glue;
demolding the dried mix and obtaining the three-dimensionally interconnected network of periodically alternating millimetric ceramic-metal composite granules with millimetric interstices;
positioning the three-dimensionally interconnected network in the part of the volume of a second mold of the hierarchical composite cast wear component to be reinforced;
pouring a second metal matrix into the second mold, and simultaneously infiltrating the millimetric interstices of the three-dimensionally interconnected network, thereby forming additional carbides selected from the group consisting of tungsten carbide, vanadium carbide, molybdenum carbide, titanium carbide, niobium carbide, hafnium carbide and zirconium carbide or mixtures thereof in the millimetric interstices;
demolding the hierarchical composite cast wear component.

8. The method according to claim 7, wherein the sintered ceramic-metal composite granules have a density comprised between 4.8 g/cm³ and 6 g/cm³, the density being determined before the casting of the second metal matrix according to ISO 3369: 2006.

9. The method according to claim 7, wherein ceramic-metal composite granules are sintered by liquid phase sintering in a furnace at a temperature of 1000-1600° C. for several minutes or hours, under vacuum, N₂, Ar, H₂ or mixtures until a porosity below 5% is reached.

10. The method according to claim 7, wherein ceramic-metal composite granules sintered by liquid phase sintering are sintered at a temperature between 1300° C. to 1500° C. for 2 hours in a vacuum furnace with about 20 mbar partial pressure of argon until a porosity<0.5 vol % is reached.
